(19) United States
(12) Patent Application Publication
(10) Pub. No.: US 2012/0110558 A1
(43) Pub. Date: May 3, 2012

(54) CUSTOMIZED BINARIES ON-THE-FLY

(75) Inventors: Hesham Anan, Bothell, WA (US); Timothy John McCracken, Woodinville, WA (US); Ryan Dale Parsell, Langley, WA (US); Mark Kramer, Camation, WA (US); Jiamin Zhu, Sammamish, WA (US)

(73) Assignee: Microsoft Corporation, Redmond, WA (US)

(21) Appl. No.: 12/915,444

(22) Filed: Oct. 29, 2010

(51) Int. Cl. G06F 9/45

(52) U.S. Cl. 717/140

(57) ABSTRACT

One or more techniques and/or systems are disclosed for dynamically generating a customized binary on the fly, without a build process. One or more customizing resources are identified for a requested binary, such as from customizing parameter identified from a decoded binary request that was sent from a client computer at runtime. Using an injection map, a location for one or more customizing resources used to customized the requested binary are identified on a resource server, which can be provided by the binary provider. The customized binary is generated by injecting the one or more customizing resources retrieved from the resource server into a decoded base binary.

### BACKGROUND

Often, web-based applications provide a rich and interactive experience for a user. Web-based applications can comprise a variety of programming that provides a simple display or an immersive interactive and graphics rich environment. Further, web-based applications may be customized for users, such as for particular uses, locations, languages, cultures, and/or markets. Customization can comprise updating text used in the application to meet the user's local language, enabling or disabling features of the application based on the market, and/or providing a customized environment based on how the application is to be used.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Customization of binaries that provide an executable application is typically performed as part of a build, preparation, and distribution process. The customization process can provide for significant overhead for a build team, for example, as the customizing resources are built as a part of the overall product build process. For example, the resources are typically built and distributed as an integrated part of the product. This may mean that subsequent updates can comprise updated customized files to be built and propagated either as a full release or a quick fix.

Currently, such as when developing localized customization, development teams may need to build all international files during the development and customization product cycle to support international versions of the product. Further, international builds may need to be propagated to test beds and production, which can add significant time, resources and dependencies to the development process. Additionally, significant overhead is added to the process in the form of development time, labor, and even file size. That is, for example, if customization resources, such as for localization, are added for all or merely some of the markets where the product is available, the file size of the distributed application may be significantly increased, but where merely part of the file is used (e.g., the part corresponding to the country/language of use, whereas parts of the file for other countries/languages is not used). The size of the distributed file may also lead to a reduced end user experience, particularly when the load time of the application is increased due to the file size, for example.

Accordingly, one or more techniques and/or systems are disclosed where a customized (e.g., localized) binary can be created on-the-fly. For example, a user may activate a web-based application, such as in their local browser, and if the localized binary for the application is not stored locally (on their machine); a customized version of the binary can be created at the runtime, and distributed to the user's machine. In this way, for example, the user experience can be improved by having a faster loading application that is customized to their locale, market, and/or environment.

In one embodiment for dynamically generating a customized binary on the fly, without a build process, one or more customizing resources are identified for a requested binary using a decoded binary request, such as sent by a client computer at runtime. Further, a location for one or more customizing resources can be identified on a resource server using an injection map. Additionally, the customized binary can be generated by injecting the one or more customizing resources, which are retrieved from the location on the resource server, into a decoded base binary.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for dynamically generating a customized binary on the fly, without a build process.

FIG. 2 is a flow diagram illustrating an example embodiment where one or more techniques described herein may be implemented.

FIG. 3 an illustrative example embodiment where one or more techniques described herein may be implemented.

FIG. 4 is a component diagram of an exemplary system for generating a customized binary on the fly.

FIG. 5 is a component diagram of an example embodiment where one or more systems described herein may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for creating a customized binary, for example, on-the-fly. As an example, a customized binary may comprise an application that runs in a browser environment or in conjunction with another application (e.g. an interactive web-based application comprising a rich multimedia experience). Further, because runtime environments, languages, and/or locales can vary by the user and/or client used to run the binary, a customization of the binary can be provided at runtime (e.g., when the binary is activated in the browser), for example, in order to provide an appropriate, and/or improved experience to the user.

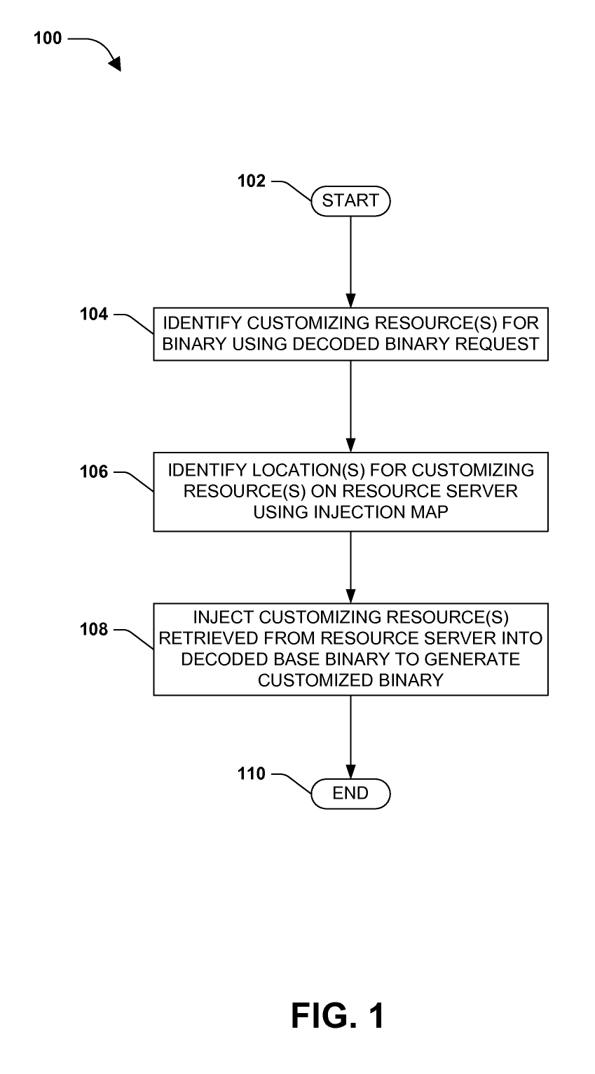

FIG. 1 is a flow diagram of an exemplary method 100 for dynamically generating a customized binary on the fly, without a build process. The exemplary method 100 begins at 102, and involves identifying one or more customizing resources for a requested binary using a decoded binary request, at 104. In one embodiment, an entity requesting the binary may comprise a consumer (e.g., user, application), developer(s), and/or testers of the binary. As an illustrative example, a consumer, such as a web-based or client-side application may activate a control that initiates a rich, user-interactive program. In this example, the consumer can request a binary (e.g., a compiled application file) that comprises elements used to run the program, such as from a server comprising the binary.

Further, binary requests can be encoded (e.g., encrypted), such as when sent over an open communications network (e.g., the Internet). In one embodiment, the decoded (e.g., decrypted) binary request can comprise information used to identify the resources for customizing the binary. For example, localization may be a customization of an application for a given culture, locale, and/or market. In this example, the decoded binary request can identify a culture customizing resource that may utilize language specific requirements, such as English, French, German, etc. Further, the decoded binary request can identify a locale resource that may utilize additional or alternate customization requirements, such as for French-Canadians, and/or local customs and/or laws. Additionally, the decoded binary request can identify a particular market resource (e.g., end-user, developer, beta-tester, etc.) that may utilize additional or alternate customization requirements, such as turning on or off particular features of the program.

At 106 in the exemplary method 100, a location for one or more of the customizing resources is identified on a resource server using an injection map. In one embodiment, an injection map comprises information that links the customizing resources called for in the decoded binary request to a location on the resource server where the respective resources are stored. In this way, for example, identifying the location for requested resources can facilitate retrieval of the resources from the identified locations.

At 108, a customized binary is generated by injecting the one or more customizing resources, which have been retrieved from the location on the resource server, into a decoded base binary. In one embodiment, the customized binary, such as compiled programmatic code (e.g., an application), comprises the base binary and customizing resources injected into the base binary. For example, the base binary can comprise code used to run the basic operations of the program that may be running as a web-based application, whereas the customizing resources can comprise code, strings, configuration information, and/or runtime environment information that customizes the base code for its intended use (e.g., localized language and/or culture information, feature configurations, operability configurations, etc.).

In one embodiment, the base binary can be prepared for injecting the customizing resources by decoding. The decoding may comprise decrypting, uncompressing, and/or opening one or more files or folders to allow the customizing resources to be injected. In one embodiment, after injecting the resources, the now customized binary can be recoded, such as encrypted, compressed, and/or closed. As an example, the base binary may comprise a file that comprises compressed data files, including a resources file. In this example, the compressed binary can be uncompressed or opened, and one or more of the customizing resources can be injected into the resource file. Further, the base binary can be recompressed or closed, yielding a customized binary.

Having generated a customized binary, the exemplary method 100 ends at 110.

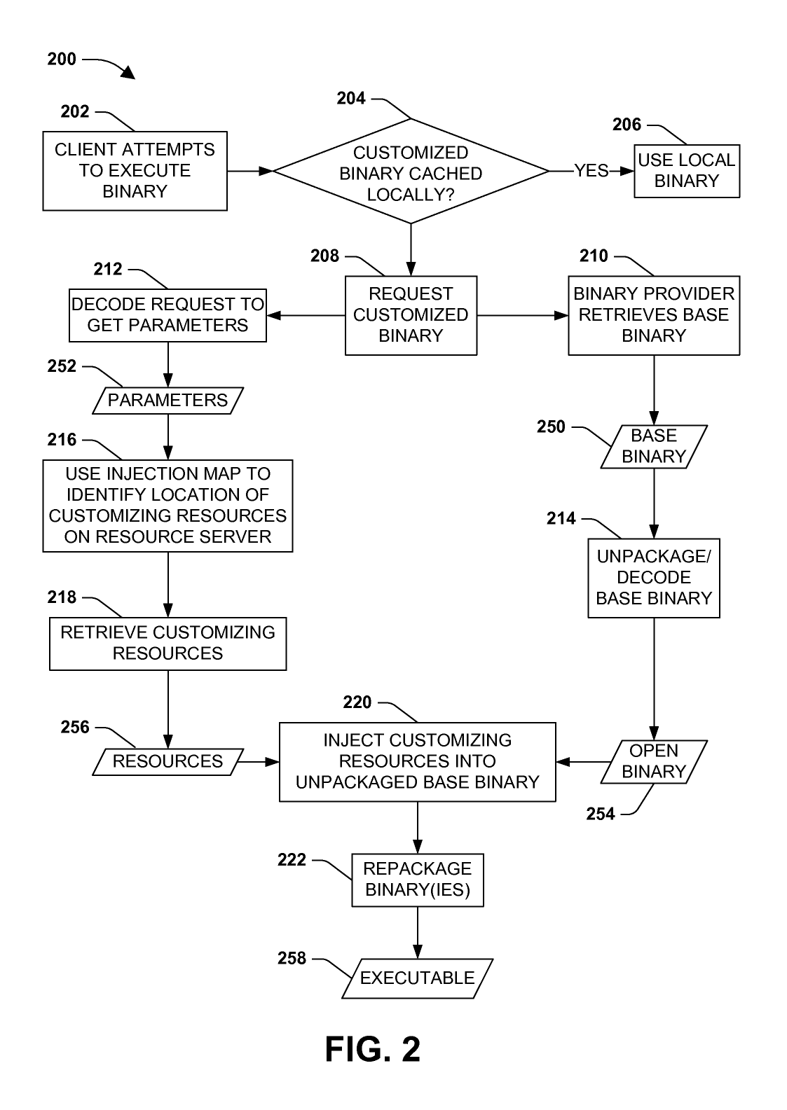

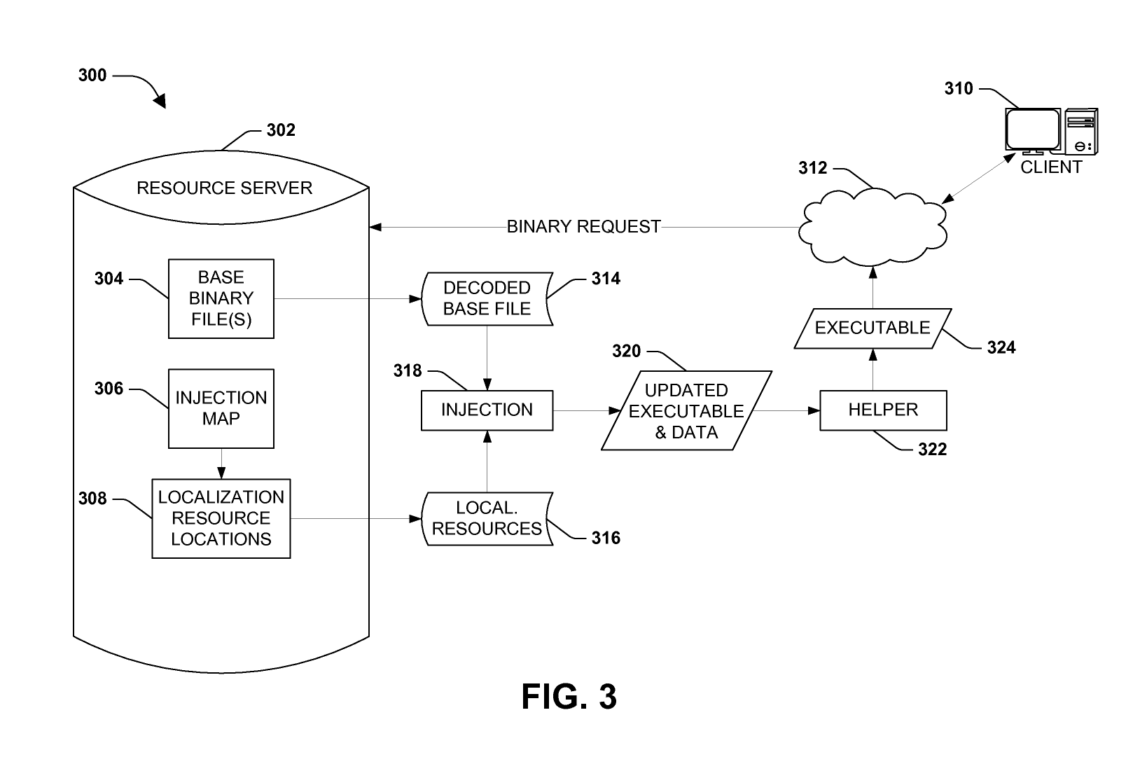

FIG. 2 is a flow diagram illustrating an example embodiment 200 where one or more techniques described herein may be implemented. While describing FIG. 2, reference will, at times, also be made to FIG. 3, which provides an illustrative example embodiment 300 where one or more techniques described herein may be implemented. At 202, a client (e.g., client computer, such as a personal computer, laptop, mobile device, etc.) attempts to execute a binary locally (e.g., on the client). For example, a user of the client may navigate to a website that utilizes one or more web-based applications (e.g., embedded media players, interactive games, interactive utilities, etc.). In this example, the user can activate one of the web-based applications (e.g., by selecting or clicking on), which may operate programmatically on the local client (e.g., in a browser) using the binary.

At 204, the client can determine whether a customized version of the binary resides locally. For example, if the user had previously activated the binary on their local client a customized version of the binary may already reside in the client local cache. In this example, when activated, the customized binary can be loaded to the local machine and stored in the local cache. If the customized binary is stored locally (YES at 204) the locally stored customized binary can be used, for example, to execute the program, at 206.

If the customized binary is not stored locally (NO at 204) a request can be made for the customized binary, at 208. For example, the application attempting to execute the binary, such as in a web-based or local application, may identify that the client's region, locale, and/or market environment utilizes particular customization, such as language specific strings, customized operation, enabled or disabled features, etc. In one embodiment, the binary request can be received at runtime of the application on the local client, at a resource server, which is remote from the client. In one embodiment, the resource server receiving the binary request may comprise a binary provider that can provide the requested binary.

In FIG. 3, as an illustrative example, the client 310 may initiate the binary locally, such as a web-app (e.g., web-based application) in a browser on the client computer 310. In this example, if the localized version of the binary is found in the cache of the client 310 the web-app can run using the local version. However, in this example, if the web-app has not been previously run on the client 310, or the cache was recently cleared, the client (e.g., the browser running on the client) can request a localized version of the web-app from a binary provider through a network connection 312, such as the Internet.

Returning to FIG. 2, at 212, the binary request can be decoded to identify parameters of the customizing resources for the requested binary. In one embodiment, the request for the binary can comprise parameters 252 for the binary, for example, that may help identify which customizing resource(s) are to be used. As an illustrative example, the parameters 252 may comprise a version number of the base binary, locale, market and/or use environment information needed to process the resource(s). Further, in this example, these parameters can be encrypted, which can be decrypted to yield content of the request, such as decrypted parameters 252.

As an example, in FIG. 3, the binary request may be made to a resource server 302 for the binary provider, which can be remotely connected to the client 310 using the network connection 312. In this example, the binary request may be decoded by the resource server 302, such that appropriate request parameters can be identified by the binary provider.

In FIG. 2, at 216, an injection map is used to identify the location of customizing resources on the resource server, where the map comprises one or more pointers to one or more locations on the resource server for respective customization resources. For example, in FIG. 3, the identified request parameter from the binary request can identify specific localization resource locations 308 stored on the resource server 302. In one embodiment, the injection map 306 can comprise storage location pointers for the specific resources identified by the parameters. In this way, for example, a location of the resources identified by the request parameters can be found, and the appropriate resources may be retrieved from the resource server 302.

At 218 in FIG. 2, the customizing resources 256, such as localization resources, are retrieved from the one or more locations on the resource server identified by the injection map. For example, in FIG. 3, the binary provider (e.g., web-app provider) can retrieve the localization resources 316 from their respective locations 308 on the resource server 302, as identified by the injection map 306. As described above, the localization resources 316 can comprise customized language strings (e.g., for application menus), culture specific features (e.g., enabling or disabling features based on the locale), and/or market or environment specific features (e.g., enabling features based on use environment, such as end-user, developer, testing), etc.

At 210 in the exemplary embodiment 200 of FIG. 2, the binary provider can retrieve the base binary 250. At 214, the base binary can be unpackage and/or decoded to yield an open/decoded binary 254. For example, as illustrated in FIG. 3, the binary request from the client 310 not only comprises the parameters for customizing the binary, but can also comprise a parameter that identifies the base binary (e.g., the base application to run on the client computer). In this example, the binary provider can identify the base binary from the request and retrieve the base file 304 from the resource server 302.

In one embodiment, the base file can be opened and/or decoded such that it is placed in an appropriate condition for customization. In this embodiment, the decoded copy of the requested binary resident on the resource server can be generated using a file helper to place the base binary in a condition that allows for code injection. For example, the base binary file can comprise a compressed (e.g., zipped) file containing a plurality of files, such as an executable, library, reference, etc. In this example, the base binary file can be uncompressed (e.g., unzipped), such that the plurality of files may be accessed, such as to add or remove information, and/or to change a setting.

In FIG. 2, at 220, the customizing resources 256 retrieved from the resource server location can be injected into the decoded copy of the requested binary 254 that was resident on the resource server. In one embodiment, the customizing resources can be injected into the decoded base binary file, where the base binary file comprises no customizing resources. For example, in FIG. 3, the base binary file 304 retrieved from the resource server 302 can comprise merely resources needed to run the binary (e.g., web-app), but where the base file does not have localization resources that may customize the base binary for a particular place, language and/or market, etc.

In one embodiment, the injected customizing resources can comprise localization strings, such as language specific strings (e.g., in French, Spanish, Russian, etc.) for menus, buttons, helper files, etc. Further, in one embodiment, the injected customizing resources can comprise configuration information, such as particular features that may be disabled or enabled based on the locale, and/or language (e.g., features that may be specific to a culture, and/or not approved for use in a location). Additionally, in one embodiment, the injected customizing resources can comprise runtime environment information, such as related to how the application may be utilized (e.g., in a lab, for beta-testing an associated product, an end-user environment, a developer of an associated product).

At 222 in the exemplary embodiment 200, the customized binary is generated by repackaging the decoded base binary with the injected customizing resources, for example, yielding an executable customized binary 258 (e.g., application to run in the client browser). In one embodiment, repackaging the decoded base binary with the injected customizing resources can comprise using a file helper to place the decoded base binary in a condition that allows for binary execution on a requesting client (e.g., creates an executable to run on the client).

As an illustrative example, in FIG. 3, the decoded/opened base file 314 is injected with the localization resources 316, at 318. For example, customized language strings can be added to the resource file associated with the binary; the library file of the binary can be updated with runtime environment information, and/or features can be enabled and/or disabled in the opened executable, etc. The injection 318 can create an updated executable file and associated data file(s) 320 for the binary application. A file helper 322 (e.g., a browser plug-in application package file helper if the binaries intended for distribution comprise a browser plug-in package) can repackage (e.g., compress and/or convert) the updated executable and data file(s) 320 to an executable file 324 that is configured to execute in a runtime environment (e.g., browser) of the client 310.

In this example, the executable file 324 can be forwarded to the client 310 over the network connection 312 (e.g., Internet) to the client. Further, the executable can be activated in the runtime environment on the client 310, such as in response to the initial binary request. As an illustrative example, a user of the client may activate a web-based application in a browser running on the client. If the web-app is not present locally, the example techniques described above can return a customized version of the web-app, which can execute in the browser. Further, in this example, a copy of the customized web-app can be cached locally on the client, such that a subsequent attempted application of the web-app may utilize the locally stored version.

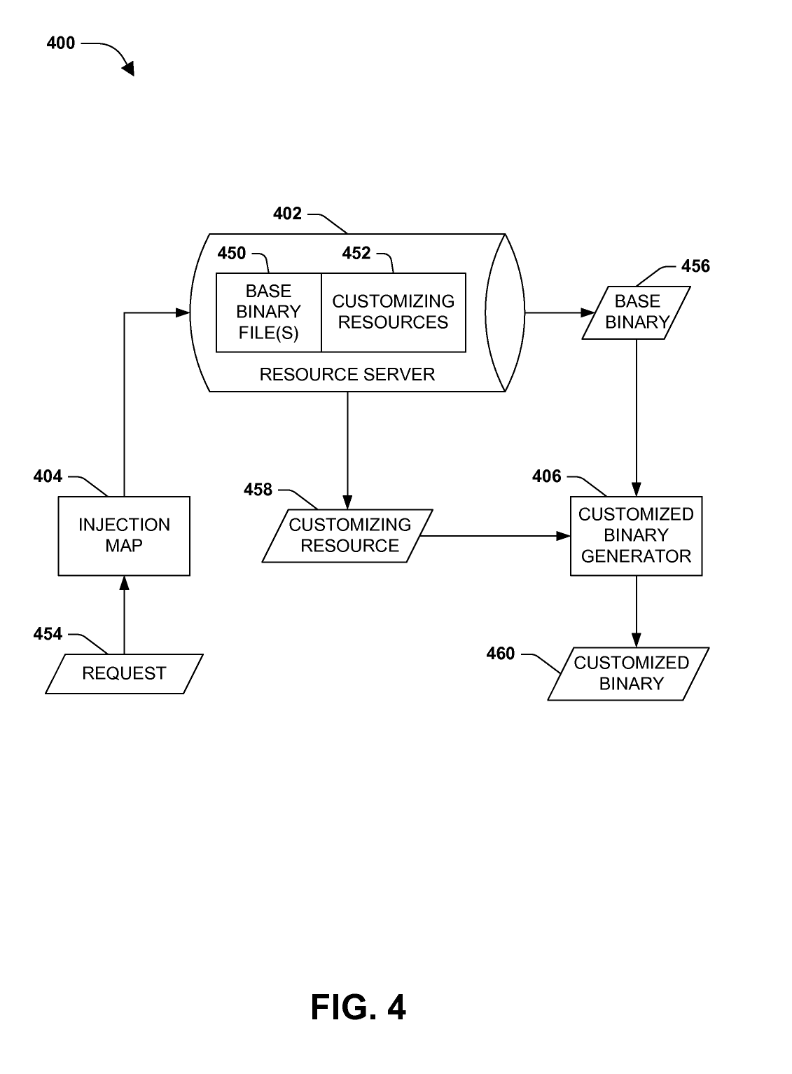

A system may be devised that provides for creating a customized binary, for example, on-the-fly. FIG. 4 is a component diagram of an exemplary system 400 for generating a customized binary on the fly. A resource server component 402 stores a base binary file(s) 450 and one or more customizing resources 452. An injection map component 404 is operably coupled with the resource server component 402, and the injection map component 404 identifies a location of one or more customizing resources 452 on the resource server 402 for a request 454 for the customized binary 460. A customized binary generation component 406 is operably coupled with the resource server 402, and the customized binary generation component 406 generates the requested customized binary 460 by injecting the one or more customizing resources retrieved 458 from the one or more identified locations on the resource server 402 into a decoded base binary 456.

For example, a request 454 for the customized binary 460 may be received from a client computer that activates the binary locally (e.g., on the local client computer), but does not have a customized version stored in local cache. In this example, the injection map component 404 can identify resources needed to customize the binary from the request 454, and find the location for the stored customizing resources 452 on the resource server 402. The customized binary generation component 406 can combine the customized resources retrieved 458 with a base binary 456, which may also be retrieved from a storage location of base binary file(s) 450 on the resource server 402, for example. In this example, combining the customizing resources retrieved 458 and the base binary 456 can generate a customized binary 460 in response to the request 454.

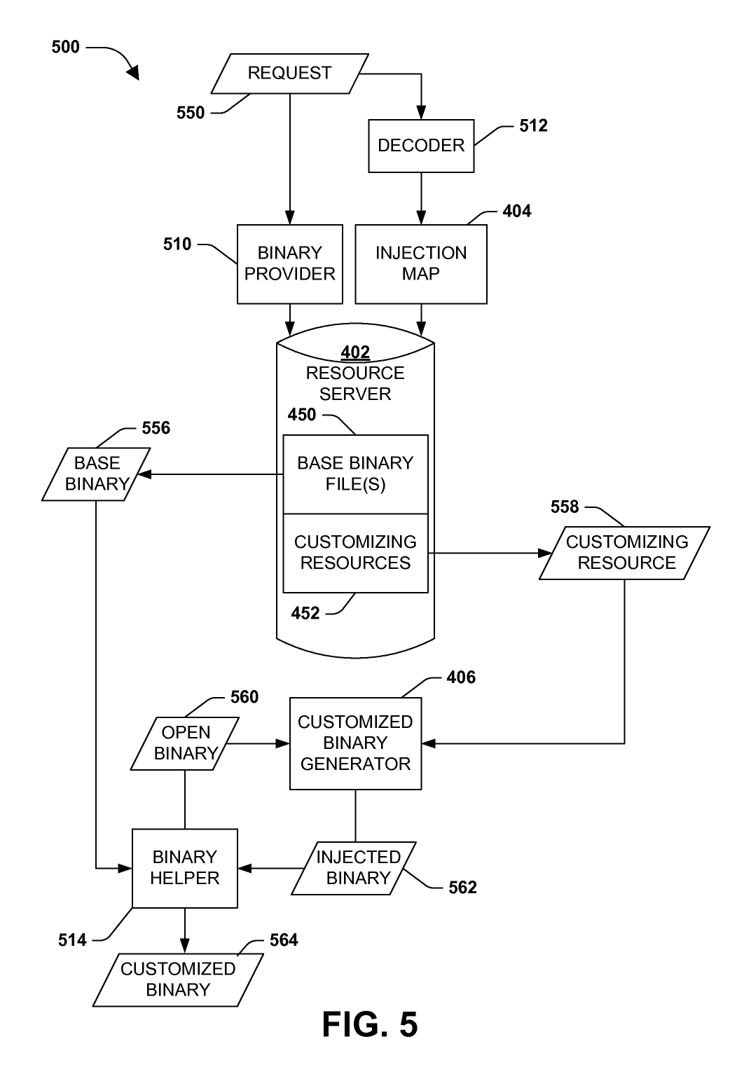

FIG. 5 is a component diagram of an example embodiment 500 where one or more systems described herein may be implemented. A binary provider 510 can be operably coupled with the resource server 402 in order to receive a request 550 for a customized binary from a requesting client. Further, the binary provider 510 can provide a decoded copy of a base binary 556 that comprises no customizing resources, such as localized customizations (e.g., language strings, customized features, etc.).

A decoding component 512 can decode the request 550 to identify parameters of customizing resources for the request. For example, the request 550 can comprise encrypted information, such as customizing parameters. In this embodiment, the decoding component 512 can decoded the parameters, such that the injection map component 404 may identify the storage locations of the requested customizing resources from the parameters, for example.

A binary helper 514 can unpackage a base binary 556 such that the base binary is in a condition to receive injected customizing resources. For example, the binary helper may produce an open binary 560 by uncompressing the base binary 556 so that file(s) of the base binary may be able to be updated with customizing resources 558 via a customized binary generator component 406, for example. Further, the binary helper 514 may be able to package a base binary 556 with an injected binary 562 to generate a customized binary 564 such that the customized binary is in a condition to execute on a client requesting the customized binary. That is, for example, the binary helper 514 may recompress or close the file(s) for the binary, which comprise the customization resources, to generate an executable file 564 that may operate in the runtime environment of the client that requested the binary. It will be appreciated that a base binary 556 may be optional with regard to such packaging and/or compressing (e.g., merely the injected binary may be (re)compressed).

In one embodiment, the customizing resources 558 can comprise localized strings for a language component of the binary, such as file names, menu items, button names, etc. Further, the customizing resources 558 can comprise market specific settings for a location component of the binary, such as enabled and/or disabled settings that are appropriate for a market, locale, or culture. Additionally, the customizing resources 558 can comprise configuration information for an environment component of the binary, such as configurations that are based on how the binary may be used (e.g., by an end-user, a developer, and/or a testing environment).

In one embodiment, the customized binary 564 can comprise one or more binary files packaged as an executable file. For example, the customized binary may comprise a compressed (e.g., zipped) file that further comprises a plurality of files (e.g., resource, library, executable) used to execute the binary in the intended runtime environment. Further the customized binary 564 can comprise the associated customizing information, such as additional language strings specific to a language and/or locale (e.g., Mexican Spanish).

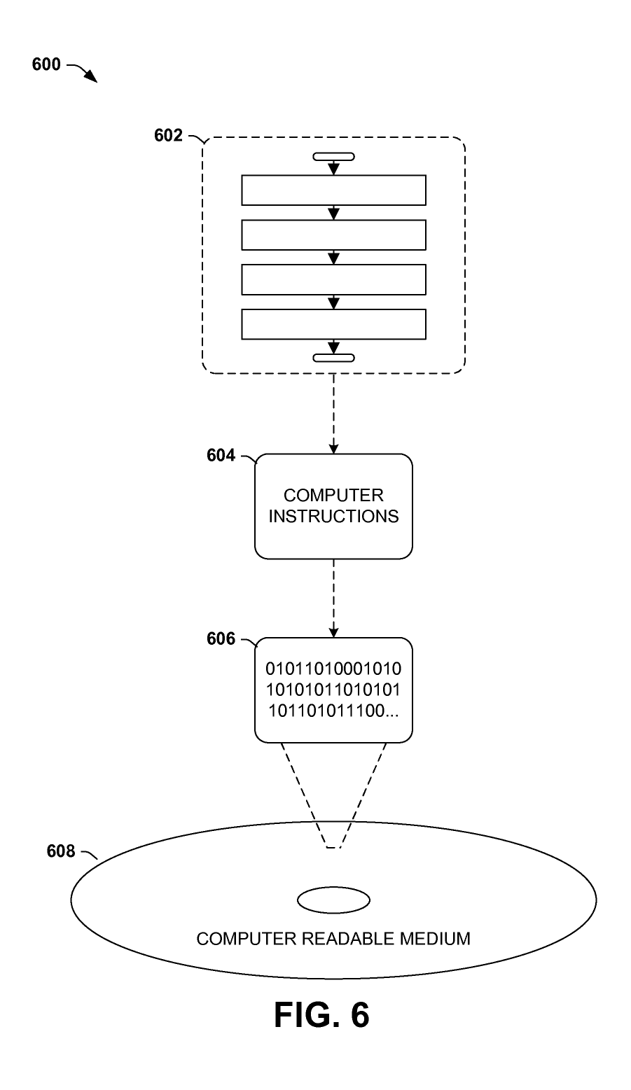

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as at least some of the exemplary method 100 of FIG. 1, for example. In another such embodiment, the processor-executable instructions 604 may be configured to implement a system, such as at least some of the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

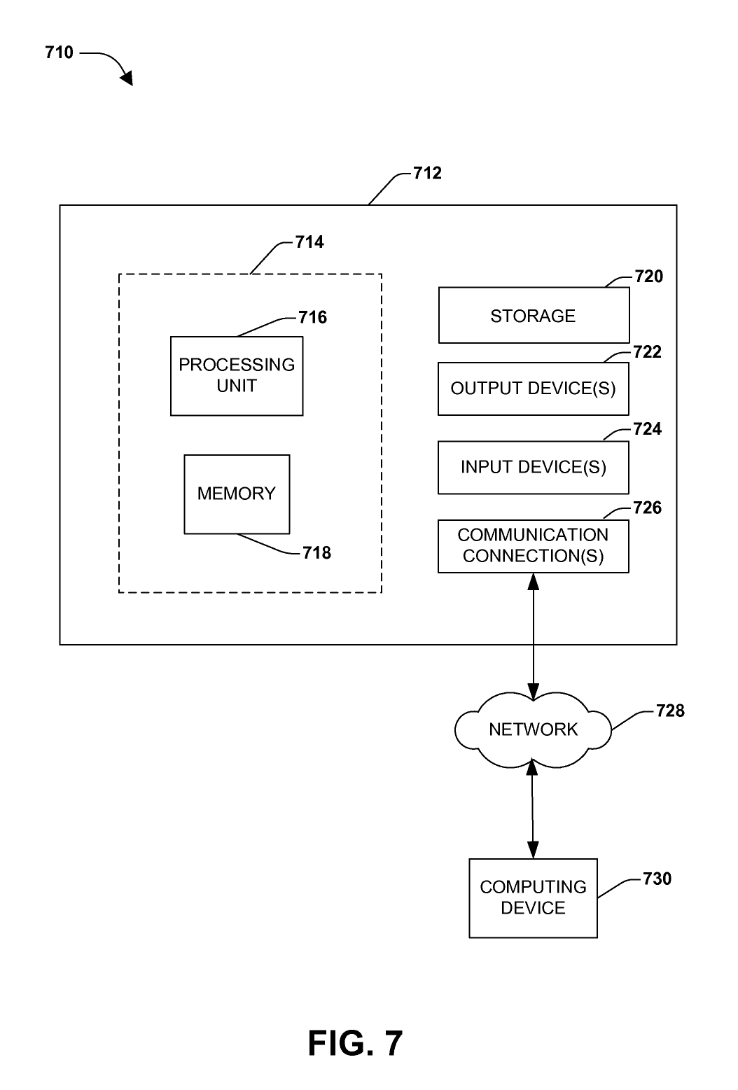

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for dynamically generating a customized binary on the fly, without a build process, comprising:
identifying one or more customizing resources for a requested binary using a decoded binary request;
identifying a location for respective one or more customizing resources on a resource server using an injection map; and
generating the customized binary comprising injecting the one or more customizing resources retrieved from the location on the resource server into a decoded base binary.

2. The method of claim 1, comprising receiving the binary request at a binary provider on the resource server.

3. The method of claim 1, comprising receiving the binary request at a runtime of the requested binary on a remote client from the resource server.

4. The method of claim 1, comprising receiving the binary request merely if the customizing resources are not cached locally for a client requesting the binary.

5. The method of claim 1, comprising decoding the binary request to identify parameters of the customizing resources for the requested binary.

6. The method of claim 1, comprising retrieving appropriate customizing resources from the resource server location using a binary provider.

7. The method of claim 1, identifying the location on the resource server for respective customizing resources using an injection map comprising using a map that comprises one or more pointers to one or more locations on the resource server for respective customization resources.

8. The method of claim 1, generating the customized binary comprising repackaging the decoded base binary with the injected customizing resources.

9. The method of claim 8, repackaging the decoded base binary with the injected customizing resources comprising using a file helper to place the decoded base binary in a condition that allows for binary execution on a requesting client.

10. The method of claim 1, comprising injecting the customizing resources retrieved from the resource server location into a decoded copy of the requested binary resident on the resource server.

11. The method of claim 10, comprising generating the decoded copy of the requested binary resident on the resource server comprising using a file helper to place the base binary in a condition that allows for code injection.

12. The method of claim 1, injecting the customizing resources retrieved from the resource server location into the decoded binary comprising injecting the customizing resources into a decoded base binary file, resident on the resource server, where the base binary file comprises no customizing resources.

13. The method of claim 1, injecting the customizing resources comprising injecting one or more of:
localization strings;
configuration information; and
runtime environment information.

14. A system for dynamically generating a customized binary on the fly, without a rebuild process, comprising:
a resource server component configured to store a base binary file and one or more customizing resources;
an injection map component operably coupled with the resource server component and configured to identify a location of one or more customizing resources on the resource server for a request for the customized binary; and
a customized binary generation component operably coupled with the resource server and configured to generate the requested customized binary by injecting the one or more customizing resources retrieved from the one or more identified locations on the resource server into a decoded base binary.

15. The system of claim 14, comprising a binary provider operably coupled with the resource server and configured to perform one or more of:
receive a request for the customized binary from a requesting client; and
provide a decoded copy of a base binary that comprises no customizing resources.

16. The system of claim 14, comprising a decoding component configured to decode the request to identify parameters of customizing resources for the request.

17. The system of claim 14 comprising a binary helper configured to perform one or more of:
unpackage a base binary such that the base binary is in a condition to receive injected customizing resources; and
package a base binary with one or more injected customizing resources to generate a customized binary such that the customized binary is in a condition to execute on a client requesting the customized binary.

18. The system of claim 14, the customizing resources comprising one or more of:
localized strings for a language component of the binary;
market specific settings for a location component of the binary; and
configuration information for an environment component of the binary.

19. The system of claim 14, the customized binary comprising:
one or more binary files packaged as an executable file; and
associated customizing information.

20. A computer-based method for dynamically generating a customized binary on the fly, without a rebuild process, comprising:
receiving a request for a requested binary at a resource server at a runtime of the requested binary on a client remote from the resource server;
decoding the request to identify parameters of one or more customizing resources for the requested binary;
identifying the one or more customizing resources on the resource server using an injection map that comprises one or more pointers to one or more locations in the resource server for respective customizing resources;
retrieving the one or more customizing resources from the one or more locations in the resource server using a binary provider; and
generating the customized binary comprising:
injecting the customizing resources retrieved from the one or more locations in the resource server into a decoded base binary version of the requested binary resident on the resource server; and
repackaging the decoded base binary with the injected customizing resources using a file helper to place the decoded binary in a condition that allows for binary execution on a requesting client.
